(19) United States
(12) Patent Application Publication
(10) Pub. No.: US 2021/0371559 A1
(43) Pub. Date: Dec. 2, 2021

(54) ETHYLENE-ALPHA-OLEFIN-NONCONJUGATED POLYENE COPOLYMER RUBBER AND RUBBER COMPOSITION

(71) Applicant: SUMITOMO CHEMICAL COMPANY, LIMITED, Tokyo (JP)

(72) Inventors: Yohei FUJII, Ichihara-shi, Chiba (JP); Sadayuki NAKANO, Ichihara-shi, Chiba (JP)

(73) Assignee: SUMITOMO CHEMICAL COMPANY, LIMITED, Tokyo (JP)

(21) Appl. No.: 17/290,934

(22) PCT Filed: Nov. 7, 2018
(86) PCT No.: PCT/JP2018/041392

§ 371 Date: May 3, 2021

(51) Int. Cl. C08F 210/18

(52) U.S. Cl. CPC C08F 210/18

(57) ABSTRACT

Disclosed is an ethylene-α-olefin-nonconjugated polyene copolymer rubber satisfying the following requirements (A) and (B):
(A) A proportion of a cyclohexane insoluble component at 25° C. is from 0.3% to 50% by mass with respect to a mass of the ethylene-α-olefin-nonconjugated polyene copolymer rubber; and
(B) A tan δ ratio calculated by the following equation:

tan δ ratio=tan δ (100° C., 5 cpm)/tan δ (100° C., 1000 cpm)

is from 3.0 to 20. The tan δ (100° C., 5 cpm) and tan δ (100° C., 1000 cpm) are a loss tangent at 100° C. and a frequency of 5 cpm and a loss tangent at 100° C. and a frequency of 1000 cpm, respectively.

### TECHNICAL FIELD

The present invention relates to an ethylene-α-olefin-nonconjugated polyene copolymer rubber and a rubber composition.

### BACKGROUND ART

Ethylene-α-olefin-nonconjugated polyene copolymer rubber is widely used in applications such as automobile parts and building materials. Various investigations have been conducted to improve the physical properties such as strength and compressive permanent set of molded articles containing ethylene-α-olefin-nonconjugated polyene copolymer rubber (for example, Patent Literature 1).

### CITATION LIST

### Patent Literature

PTL 1: Japanese Unexamined Patent Application Publication No. 2003-040934

### SUMMARY OF INVENTION

Ethylene-α-olefin-nonconjugated polyene copolymer rubber is typically kneaded together with other components such as a vulcanizing agent and a reinforcing agent, and a molded article is produced using a rubber composition formed by kneading. Conventionally, there has been a case in which the viscosity of the kneaded material is likely to change depending on the kneading conditions for obtaining the rubber composition. It is desirable that the change in viscosity due to the difference in kneading conditions is small in order to produce a rubber composition exhibiting stable quality.

### Technical Problem

An object of the present invention is to achieve improvement in the viscosity stability in kneading conducted to obtain a rubber composition with regard to an ethylene-α-olefin-nonconjugated polyene copolymer rubber which can provide a molded article having a favorable mechanical strength.

### Solution to Problem

An aspect of the present invention relates to an ethylene-α-olefin-nonconjugated polyene copolymer rubber. The ethylene-α-olefin-nonconjugated polyene copolymer rubber according to an aspect of the present invention satisfies the following requirements (A) and (B).
(A) A proportion of a cyclohexane insoluble component at 25° C. is from 0.3% to 50% by mass with respect to a mass of the ethylene-α-olefin-nonconjugated polyene copolymer rubber.
(B) A tan δ ratio calculated by the following equation:

tan δ ratio=tan δ (100° C., 5 cpm)/tan δ (100° C., 1000 cpm)
is from 3.0 to 20, in which tan δ (100° C., 5 cpm) and tan δ (100° C., 1000 cpm) are a loss tangent at 100° C. and a frequency of 5 cpm and a loss tangent at 100° C. and a frequency of 1000 cpm, respectively.

The proportion of the cyclohexane insoluble component of the requirement (A) is related to the content of the ethylene unit in the ethylene-α-olefin-nonconjugated polyene copolymer rubber. It can be said that the content of the ethylene unit in the ethylene-α-olefin-nonconjugated polyene copolymer rubber in which the proportion of the cyclohexane insoluble component is within the above range is great to a certain extent. Ethylene-α-olefin-nonconjugated polyene copolymer rubber in which the content of the ethylene unit is great tends to have a high mechanical strength.

The tan δ ratio of the requirement (B) is related to the degree of entanglement of the ethylene-α-olefin-nonconjugated polyene copolymer rubber. The tan δ ratio of from 3.0 to 20 is relatively great as an ethylene-α-olefin-nonconjugated polyene copolymer rubber, which means that the entanglement of molecular chains is relatively diminished. It is considered that the entanglement is released in the process of kneading and the viscosity thus decreases when the degree of entanglement of molecular chains is great. The inventors of the present invention presume that a change in viscosity hardly occurs in the process of kneading when the entanglement of molecular chains is diminished before kneading.

Another aspect of the present invention relates to a rubber composition containing the ethylene-α-olefin-nonconjugated polyene copolymer rubber.

### ADVANTAGEOUS EFFECTS OF INVENTION

The present invention can achieve improvement in the viscosity stability in kneading conducted to obtain a rubber composition with regard to an ethylene-α-olefin-nonconjugated polyene copolymer rubber which can provide a molded article having a favorable mechanical strength.

### Description of Embodiments

Hereinafter, embodiments of the present invention will be described. However, the present invention is not limited to the following embodiments.

Ethylene-α-olefin-nonconjugated polyene copolymer rubber)

The ethylene-α-olefin-nonconjugated polyene copolymer rubber according to an embodiment contains an ethylene unit, an α-olefin unit, and a nonconjugated polyene unit as main monomer units. The total content of the ethylene unit, the α-olefin unit, and the nonconjugated polyene unit in the ethylene-α-olefin-nonconjugated polyene copolymer rubber may be 60% by mass or more and 100% by mass or less or 80% by mass or more and 100% by mass or less with respect to the entire mass of the ethylene-α-olefin-nonconjugated polyene copolymer rubber. In the present specification, the term “monomer name +unit” such as “ethylene unit”, “α-olefin unit”, or “non-conjugated polyene unit” means a monomer unit derived from each monomer.

The ethylene-α-olefin-nonconjugated polyene copolymer rubber according to the present embodiment satisfies the following requirements (A) and (B).
(A) A proportion of a cyclohexane insoluble component at 25° C. is from 0.3% to 50% by mass with respect to a mass of the ethylene-α-olefin-nonconjugated polyene copolymer rubber.
(B) A tan δ ratio calculated by the following equation:

tan δ ratio=tan δ (100° C., 5 cpm)/tan δ (100° C., 1000 cpm)
is from 3.0 to 20. tan δ (100° C., 5 cpm) and tan δ (100° C., 1000 cpm) are a loss tangent at 100° C. and a frequency of 5 cpm and a loss tangent at 100° C. and a frequency of 1000 cpm, respectively.

The ethylene-α-olefin-nonconjugated polyene copolymer rubber which satisfies the proportion of the cyclohexane insoluble component stipulated in the requirement (A) can provide a molded article having a high mechanical strength such as a high tensile strength. From the same viewpoint, the proportion of the cyclohexane insoluble component in the ethylene-α-olefin-nonconjugated polyene copolymer rubber at 25° C. may be from 0.3% to 50% by mass, 10% to 50% by mass, 20% to 50% by mass, 10% to 40% by mass or 20% to 40% by mass, with respect to the mass of the ethylene-α-olefin-nonconjugated polyene copolymer rubber. The ethylene-α-olefin-nonconjugated polyene copolymer rubber in which the proportion of the cyclohexane insoluble component is within the above range can be obtained by, for example, adjusting the content of the ethylene unit.

The ethylene-α-olefin-nonconjugated polyene copolymer rubber which satisfies the tan δ ratio stipulated in the requirement (B) can improve the viscosity stability in kneading conducted to obtain a rubber composition. From the same viewpoint, the tan δ ratio of the ethylene-α-olefin-nonconjugated polyene copolymer rubber may be from 0.3 to 20, 3.0 to 15, or 3.0 to 10. The ethylene-α-olefin-nonconjugated polyene copolymer rubber in which the tan δ ratio is within the above range can be obtained by, for example, adjusting the content of the ethylene unit, the kind of the nonconjugated polyene unit, or the content of the nonconjugated polyene unit.

The number of carbon atoms in the α-olefin composing the ethylene-α-olefin-nonconjugated polyene copolymer rubber may be 3 or more and 20 or less. Specific examples of the α-olefin may include straight chain olefins such as propylene, 1-butene, 1-pentene, 1-hexene, 1-heptene, 1-octene, 1-nonene, and 1-decene; branched chain olefins such as 3-methyl-1-butene, 3-methyl-1-pentene, and 4-methyl-1-pentene; and cyclic olefins such as vinylcyclohexane. These may be used singly or in combination. The α-olefin may be propylene and/or 1-butene or may be propylene.

The nonconjugated polyene may be a nonconjugated polyene having 3 or more and 20 or less carbon atoms. The nonconjugated polyene may be a chain nonconjugated diene, a cyclic nonconjugated diene, a triene, or any combination thereof.

Examples of the chain nonconjugated diene may include 1,4-hexadiene, 1,6-octadiene, 2-methyl-1,5-hexadiene, 6-methyl-1,5-heptadiene, and 7-methyl-1,6-octadiene.

Examples of the cyclic nonconjugated diene may include cyclohexadiene, dicyclopentadiene, 5 -vinylnorbornene, 5 -ethylidene-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(6-heptenyl)-2-norbornene, 5-(7-octenyl)-2-norbornene, 5-methylene-2-norbornene, and 6-chloromethyl-5-isopropenyl-2-norbornene.

Examples of the triene may include 4-ethylidene-8-methyl-1,7-nonadiene, 5,9,13-trimethyl-1,4,8,12-tetradecadiene, 4-ethylidene-12-methyl-1,11-pentadecadiene, 2,3-diisopropylidene-5-norbornene, 2-ethylidene-3-isopropylidene-5-norbornene, 2-propenyl-2,2-norbornadiene, 1,3,7-octatriene, 6,10-dimethyl-1,5,9-undecatriene, 5,9-dimethyl-1,4,8-decatriene, 13-ethyl-9-methyl-1,9,12-pentadecatriene, 5,9,8,14,16-pentamethyl-1,7,14-hexadecatriene, and 1,4,9-decatriene.

The nonconjugated polyene may be 5-ethylidene-2-norbornene, dicyclopentadiene, 5-vinylnorbornene, or a combination of two or more kinds selected from these. The nonconjugated polyene may be a combination of 5-ethylidene-2-norbornene and dicyclopentadiene, or 5-ethylidene-2-norbornene only.

The ethylene-α-olefin-nonconjugated polyene copolymer rubber tends to be likely to satisfy the requirement (B), when the content of the nonconjugated polyene unit that is likely to be a starting point of crosslinking is low. Examples of the nonconjugated polyene unit that is likely to be a starting point of crosslinking includes cyclopentadiene. When the content of the nonconjugated polyene unit that is likely to be a starting point of crosslinking is 2% by mass or less, or 1% by mass or less, the ethylene-α-olefin-nonconjugated polyene copolymer rubber easily satisfies the requirement (B).

The content of the ethylene unit may be from 50% to 90% by mass with respect to the total amount of the ethylene unit, the α-olefin unit and the nonconjugated polyene unit. A molded article having a high mechanical strength is particularly likely to be obtained when the content of the ethylene unit is relatively high as described above. From the viewpoint of further improvement in mechanical strength and the like, the content of the ethylene unit may be from 60% to 90% by mass, or 65% to 90% by mass with respect to the total amount of the ethylene unit, the propylene unit and the nonconjugated polyene unit. The ethylene-α-olefin-nonconjugated polyene copolymer rubber with the content of the ethylene unit within the ranges of 50% to 90% by mass, 60% to 90% by mass, or 65% to 90% by mass particularly easily satisfies the requirement (A) and (B).

The content of the nonconjugated polyene unit in the ethylene-α-olefin-nonconjugated polyene copolymer rubber may be from 0 to 20 in terms of iodine value (unit: g/100 g of ethylene-α-olefin-nonconjugated polyene copolymer rubber). The content of the nonconjugated polyene unit (the iodine value of the copolymer rubber) in this range leads to an effect of less branching degree. The less branching degree tends to result in further improvement of the viscosity stability in kneading. From the same viewpoint, the content of the nonconjugated polyene unit may be from 5 to 20 or 5 to 15 in terms of iodine value. The ethylene-α-olefin-nonconjugated polyene copolymer rubber with the iodine value of 0 to 20, 5 to 20 or 5 to 15 particularly easily satisfies the requirements (B).

Specific examples of the ethylene-α-olefin-nonconjugated polyene copolymer rubber include ethylene-propylene-5-ethylidene-2-norbornene copolymer rubber, ethylene-propylene-dicyclopentadiene copolymer rubber, ethylene-propylene-1,4-hexadiene copolymer rubber, ethylene-propylene-1,6-octadiene copolymer rubber, ethylene-propylene-2-methyl-1,5-hexadiene copolymer rubber, ethylene-propylene-6-methyl-1,5-heptadiene copolymer rubber, ethylene-propylene-7-methyl-1,6-octadiene copolymer rubber, ethylene-propylene-cyclohexadiene copolymer rubber, ethylene-propylene-5-vinylnorbornene copolymer rubber, ethylene-propylene-5-(2-propenyl)-2-norbornene copolymer rubber, ethylene-propylene-5-(3-butenyl)-2-norbornene copolymer rubber, ethylene-propylene-5-(4-pentenyl)-2-norbornene copolymer rubber, ethylene-propylene-5-(5-hexenyl)-2-norbornene copolymer rubber, ethylene-propylene-5-(6-heptenyl)-2-norbornene copolymer rubber, ethylene-propylene-5-(7-octenyl)-2-norbornene copolymer rubber, ethylene-propylene-5-methylene-2-norbornene copolymer rubber, ethylene-propylene-4-ethylidene-8-methyl-1,7-nonadiene copolymer rubber, ethylene-propylene-5,9,13-trimethyl-1,4,8,12-tetradecadiene copolymer rubber, ethylene-propylene-4-ethylidene-12-methyl-1,11-pentadecadiene copolymer rubber, ethylene-propylene-6-chloromethyl-5-isopropenyl-2-norbornene copolymer rubber, ethylene-propylene-2,3-diisopropylidene-5-norbornene copolymer rubber, ethylene-propylene-2-ethylidene-3-isopropylidene-5-norbornene copolymer rubber, ethylene-propylene-2-propenyl-2,2-norbornadiene copolymer rubber, ethylene-propylene-1,3,7-octatriene copolymer rubber, ethylene-propylene-6,10-dimethyl-1,5,9-undecatriene copolymer rubber, ethylene-propylene-5,9-dimethyl-1,4,8-decatriene copolymer rubber, ethylene-propylene-13-ethyl-9-methyl-1,9,12-pentadecatriene copolymer rubber, ethylene-propylene-5,9,8,14,16-pentamethyl-1,7,14-hexadecatriene copolymer rubber, and ethylene-propylene-1,4,9-decatriene copolymer rubber. Two or more kinds of copolymer rubbers selected from these may be combined.

The ethylene-α-olefin-nonconjugated polyene copolymer rubber may be ethylene-propylene-5-ethylidene-2-norbornene copolymer rubber, ethylene-propylene-dicyclopentadiene copolymer rubber, ethylene-propylene-5-vinylnorbornene copolymer rubber, or any combination thereof, or may be ethylene-propylene-5-ethylidene-2-norbornene copolymer rubber.

The content of the ethylene unit, the content of the α-olefin unit, and the iodine value are values in the sum of the combination of two or more kinds in a case in which two or more kinds of ethylene-α-olefin-nonconjugated polyene copolymer rubbers are combined.

Process oil such as paraffin-based oil and naphthene-based oil may be added to the ethylene-α-olefin-nonconjugated polyene copolymer rubber to form an oil extended rubber.

The intrinsic viscosity of the ethylene-α-olefin-nonconjugated polyene copolymer rubber measured in tetralin at 135° C. may be from 1 to 5 dl/g. The advantageous effect of further improving the processability in kneading can be obtained when the intrinsic viscosity is within this range. With using the ethylene-α-olefin-nonconjugated polyene copolymer rubber with superior processability, kneaded material that is kneaded uniformly can be obtained more easily. From the same viewpoint, the intrinsic viscosity of the ethylene-α-olefin-nonconjugated polyene copolymer rubber may be from 1 to 4 dl/g, or 1 to 3 dl/g.

The molecular weight distribution (Mw/Mn) of the ethylene-α-olefin-nonconjugated polyene copolymer rubber may be from 2 to 5. The advantageous effect of making processability in kneading consistent with mechanical property at high levels can be obtained, when the molecular weight distribution of the ethylene-α-olefin-nonconjugated polyene copolymer rubber is within this range. From the same viewpoint, the molecular weight distribution of the ethylene-α-olefin-nonconjugated polyene copolymer rubber may be from 2 to 4 or 2 to 3.5.

In the present specification, the molecular weight distribution is a ratio (Mw/Mn) calculated from the weight average molecular weight (Mw) and number average molecular weight (Mn) in terms of polystyrene measured by gel permeation chromatography (GPC method).

The measurement conditions in the GPC method for measuring the weight average molecular weight and number average molecular weight are, for example, as follows.
GPC apparatus: HLC-8121 GPC/HT (trade name) manufactured by Tosoh Corporation
Column: TSKgel GMHHR-H(S) HT (trade name) manufactured by Tosoh Corporation
Standard substance for molecular weight: polystyrene having molecular weight of 500 or more and 20,000,000 or less
Flow rate of eluting solvent: 1.0 mL/min
Concentration of sample: 1 mg/mL
Measuring temperature: 140° C.
Eluting solvent: orthodichlorobenzene
Injection volume: 500 μL
Detector: differential refractometer

The glass transition temperature of the ethylene-α-olefin-nonconjugated polyene copolymer rubber may be from −55° C. to −30° C. A molded article having superior physical properties at a low temperature is likely to be obtained when the glass transition temperature of the copolymer is within this range. From the same viewpoint, the glass transition temperature of the ethylene-α-olefin-nonconjugated polyene copolymer rubber may be from −55° C. to −35° C. or −50° C. to −35° C. The glass transition temperature herein is a temperature at the midpoint of the glass transition portion in the thermogram obtained by differential scanning calorimetry at a rate of temperature increase of 5°/min

Method of Producing ethylene-α-olefin-nonconjugated Polyene Copolymer Rubber

The ethylene-α-olefin-nonconjugated polyene copolymer rubber according to the present embodiment can be obtained, for example, by a method comprising a step of copolymerizing a monomer mixture containing ethylene, an α-olefin, and a non-conjugated polyene in the presence of a catalyst such as a so-called Ziegler-Natta catalyst or a metallocene catalyst.

As the catalyst for the copolymerization, it is possible to use a catalyst obtained by bringing a vanadium compound represented by the following Formula (1) into contact with an organoaluminum compound represented by the following Formula (2).

VO(OR)ₘX₃₋ₘ (1)

In the formula, R represents a straight chain hydrocarbon group having 1 or more and 8 or less carbon atoms, X represents a halogen atom, and m represents a number satisfying 0<m<=3.

R″ⱼAlX″₃₋ⱼ (2)

In the formula, R″ represents a hydrocarbon group, X″ represents a halogen atom, and j represents a number satisfying 0<j<=3.

R″ in Formula (2) may be an alkyl group having from 1 to 10 carbon atoms. Examples of the alkyl group having from 1 to 10 carbon atoms include a methyl group, an ethyl group, an n-propyl group, an iso-propyl group, an n-butyl group, an iso-butyl group, a pentyl group, and a hexyl group. Examples of X″ may include a fluorine atom and a chlorine atom. j may be a number satisfying 0<j<=2.

Specific examples of the organoaluminum compound represented by Formula (2) include (C₂H₅)₂AlCl, (n-C₄H₉)₂AlCl, (iso-C₄H₉)₂AlCl, (n-C₆H₁₃)₂AlCl, (C₂H₅)_{1.5}AlCl_{1.5}, (n-C₄H₉)_{1.5}AlCl_{1.5}, (iso-C₄H₉)_{1.5}AlCl_{1.5}, (n-C₆H₁₃)_{1.5}AlCl_{1.5}, C₂H₅AlCl₂, (n-C₄H₉)AlCl₂, (iso-C₄H₉)AlCl₂, and (n-C₆H₁₃)AlCl₂. The organoaluminum compound may be (C₂H₅)₂ AlCl, (C₂H₅)_{1.5}AlCl_{1.5}, or C₂H₅AlCl₂. These may be used singly or in combination.

The molar ratio (mole of organoaluminum compound/mole of vanadium compound) of the used amount of the organoaluminum compound represented by Formula (2) to the used amount of the vanadium compound represented by Formula (1) may be from 0.1 to 50, from 1 to 30 or less, from 2 to 15, or from 3 to 10. The intrinsic viscosity, Mw/Mn and the like of the ethylene-α-olefin-nonconjugated polyene copolymer rubber can be adjusted by adjusting the molar ratio. For example, the intrinsic viscosity of the ethylene-α-olefin-nonconjugated polyene copolymer rubber tends to increase and Mw/Mn and Mw/Mn tend to decrease when the molar ratio is great.

The polymerization reaction may be conducted, for example, in one polymerization tank or in two polymerization tanks connected in series by two stages. It is possible to supply a monomer, a catalyst, and, if necessary, other components to the polymerization tank and to polymerize the monomer in the polymerization tank.

The polymerization reaction is usually conducted in a solvent. Examples of the solvent to be used in the polymerization may include an inert solvent such as an aliphatic hydrocarbon such as propane, butane, isobutane, pentane, hexane, heptane, or octane; or an alicyclic hydrocarbon such as cyclopentane or cyclohexane. These may be used singly or in combination. The solvent may contain an aliphatic hydrocarbon.

The polymerization temperature may be from 0° C. to 200° C., from 20° C. to 150° C., or from 30° C. to 120° C. The polymerization pressure may be from 0.1 to 10 MPa, from 0.1 to 5 MPa, or from 0.1 to 3 MPa. It is possible to adjust Mw/Mn and the like of the ethylene-α-olefin-nonconjugated polyene copolymer rubber by adjusting the polymerization temperature. For example, Mw/Mn tends to decrease when the polymerization temperature is low.

At the time of polymerization, hydrogen may be supplied into the polymerization tank as a molecular weight modifier if necessary. The amount of hydrogen to be supplied into the polymerization tank may be from 0.001 to 0.1 NL, from 0.005 to 0.05 NL, or from 0.01 to 0.04 NL per 1 kg of the solvent to be supplied into the polymerization tank. It is possible to adjust Mw/Mn, intrinsic viscosity and the like of the ethylene-α-olefin-nonconjugated polyene copolymer rubber by adjusting the amount of hydrogen supplied. For example, Mw/Mn tends to decrease when the amount of hydrogen supplied is great. The intrinsic viscosity tends to increase when the amount of hydrogen supplied is small.

The amount of the vanadium compound to be supplied into the polymerization tank may be from 0.002 to 0.2 parts by mass or from 0.003 to 0.1 parts by mass per 100 parts by mass of the solvent to be supplied into the polymerization tank. There is a tendency that the intrinsic viscosity can be increased when the quantitative ratio of the vanadium compound to the solvent is great.

Rubber Composition

The rubber composition according to an embodiment contains the ethylene-α-olefin-nonconjugated polyene copolymer rubber according to the embodiment described above. The content of the ethylene-α-olefin-nonconjugated polyene copolymer rubber in the rubber composition may be from 10% to 90% by mass, from 20% to 90% by mass, from 10% to 80% by mass, or from 20% to 80% by mass or less with respect to the entire mass of the rubber composition.

The rubber composition of the present embodiment may further contain at least one kind of other component selected from the group consisting of a rubber component other than the ethylene-α-olefin-nonconjugated polyene copolymer rubber, a reinforcing agent, a softening agent, a vulcanizing agent, a vulcanization accelerator, a vulcanization aid, a processing aid, a rubber antioxidant, and a silane coupling agent in addition to the ethylene-α-olefin-nonconjugated polyene copolymer rubber. The rubber composition may further contain a reinforcing agent, a vulcanizing agent or both of these. The rubber composition may contain a vulcanizing agent and a vulcanization accelerator or a vulcanization aid, or both of these.

The rubber components other than the ethylene-α-olefin-nonconjugated polyene copolymer rubber, which can be contained in the rubber composition may be, for example, at least one kind selected from natural rubber, isoprene rubber, butadiene rubber, styrene butadiene rubber, or butyl rubber.

The content of the other rubber components in the rubber composition may be from 10 to 40 parts by mass or from 15 to 30 parts by mass with respect to 100 parts by mass of the content of the ethylene-α-olefin-nonconjugated polyene copolymer rubber.

The reinforcing agent is an additive for improving the mechanical properties of the vulcanizate of a rubber composition as described in Handbook of Compounding Ingredients for Rubber and Plastics (published by Rubber Digest Co., Ltd., on Apr. 20, 1981). The reinforcing agent may contain at least one kind selected from, for example, carbon black, silica produced by a dry method, silica produced by a wet method, synthetic silicate-based silica, colloidal silica, basic magnesium carbonate, activated calcium carbonate, heavy calcium carbonate, light calcium carbonate, mica, magnesium silicate, aluminum silicate, lignin, aluminum hydroxide, and magnesium hydroxide.

The content of the reinforcing agent in the rubber composition may be from 20 to 250 parts by mass, from 30 to 200 parts by mass, or from 40 to 180 parts by mass with respect to 100 parts by mass of the content of the ethylene-α-olefin-nonconjugated polyene copolymer rubber.

The softening agent may contain, for example, at least one kind selected from paraffin-based oil, naphthene-based oil, petroleum asphalt, petroleum jelly, coal tar pitch, castor oil, linseed oil, factice, dense wax, or ricinoleic acid. The softening agent may be a process oil or a lubricating oil.

The content of the softening agent in the rubber composition may be from 5 to 250 parts by mass, from 5 to 150 parts by mass, or from 5 to 80 parts by mass with respect to 100 parts by mass of the content of the ethylene-α-olefin-nonconjugated polyene copolymer rubber.

The vulcanizing agent is a component for crosslinking the ethylene-a-olefin-nonconjugated polyene copolymer rubber to form a vulcanizate. The vulcanizing agent may be sulfur, a sulfur-based compound, an organic peroxide, or any combination thereof.

The sulfur may be, for example, powdered sulfur, precipitated sulfur, colloidal sulfur, surface-treated sulfur, or insoluble sulfur.

The total content of sulfur and sulfur-based compound in the rubber composition may be from 0.01 to 10 parts by mass or from 0.1 to 5 parts by mass with respect to 100 parts by mass of the content of the ethylene-α-olefin-nonconjugated polyene copolymer rubber.

Examples of the organic peroxide includes dicumyl peroxide, 2,5-dimethyl-2,5-di(t-butylperoxy)hexane, 2,5-dimethyl-2,5-di(benzoylperoxy)hexane, 2,5-dimethyl-2,5-di(t-butylperoxy)hexyne-3, di-t-butyl peroxide, di-t-butyl peroxide-3,3,5-trimethylcyclohexane, and t-butyl hydroperoxide. The organic peroxide may be dicumyl peroxide, di-t-butyl peroxide, di-t-butyl peroxide-3,3,5-trimethylcyclohexane, or any combination thereof, or may be dicumyl peroxide.

The content of the organic peroxide in the rubber composition may be from 0.1 to 15 parts by mass or from 1 to 8 parts by mass with respect to 100 parts by mass of the content of the ethylene-α-olefin-nonconjugated polyene copolymer rubber.

The vulcanization accelerator is a component for shortening the vulcanization time by promoting the crosslinking reaction by the vulcanizing agent. The vulcanization accelerator may contain at least one kind of compound selected from, for example, tetramethylthiuram monosulfide, tetramethylthiuram disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazole sulfenamide, 2-mercaptobenzothiazole, 2-(2,4-dinitrophenyl)mercaptobenzothiazole, 2-(2,6-diethyl-4-morpholinothio)benzothiazole, dibenzothiazyl disulfide, diphenyl guanidine, triphenyl guanidine, di-o-tolylguanidine, orthotolyl-bi-guanide, diphenyl guanidine-phthalate, n-butyraldehyde aniline, hexamethylenetetramine, acetaldehyde ammonia, 2-mercaptoimidazoline, thiocarbanilide, diethyl thiourea, dibutyl thiourea, trimethyl thiourea, di-o-tolylthiourea, zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthate, or ethylene thiourea.

The content of the vulcanization accelerator in the rubber composition may be from 0.05 to 20 parts by mass or from 0.1 to 8 parts by mass with respect to 100 parts by mass of the content of the ethylene-α-olefin-nonconjugated polyene copolymer rubber.

The vulcanization aid is a component used in combination with the vulcanization accelerator or alone for increasing the crosslinking density of vulcanizate by promoting the crosslinking reaction by the vulcanizing agent. The vulcanization aid may contain at least one kind of compound selected from, for example, triallyl isocyanurate, N,N′-m-phenylene bismaleimide, methacrylic acid, methyl methacrylate, ethyl methacrylate, propyl methacrylate, isopropyl methacrylate, n-butyl methacrylate, i-butyl methacrylate, sec-butyl methacrylate, t-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethylene glycol monomethacrylate, polypropylene glycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butanediol diacrylate, ethylene glycol dimethacrylate, 1,3-butylene glycol dimethacrylate, neopentyl glycol dimethacrylate, 1,6-hexanediol dimethacrylate, diethylene glycol dimethacrylate, triethylene glycol dimethacrylate, polyethylene glycol dimethacrylate, dipropylene glycol dimethacrylate, polypropylene glycol dimethacrylate, trimethylolethane trimethacrylate, trimethylolpropane trimethacrylate, allyl glycidyl ether, N-methylolmethacrylamide, 2,2-bis(4-methacryloxypolyethoxyphenyl)propane, aluminum methacrylate, zinc methacrylate, calcium methacrylate, magnesium methacrylate, 3-chloro-2-hydroxypropyl methacrylate, zinc oxide, and magnesium oxide.

The content of the vulcanization aid in the rubber composition may be from 0.05 to 15 parts by mass or from 0.1 to 8 parts by mass with respect to 100 parts by mass of the content of the ethylene-α-olefin-nonconjugated polyene copolymer rubber.

The processing aid contains, for example, a fatty acid, a metal salt of a fatty acid, an ester of a fatty acid, a glycol, or any combination thereof. Examples of the fatty acid include oleic acid, palmitic acid, and stearic acid. Examples of the metal salt of a fatty acid include zinc laurate, zinc stearate, barium stearate, and calcium stearate. Examples of the glycol include ethylene glycol and polyethylene glycol.

The content of the processing aid in the rubber composition may be from 0.2 to 10 parts by mass or from 0.3 to 8 parts by mass with respect to 100 parts by mass of the content of the ethylene-α-olefin-nonconjugated polyene copolymer rubber.

The silane coupling agent may be at least one kind selected from, for example, a silane-based silane coupling agent, a vinyl-based silane coupling agent, a methacrylic silane coupling agent, an epoxy-based silane coupling agent, a mercapto-based silane coupling agent, a sulfur-based silane coupling agent, an amino-based silane coupling agent, a ureido-based silane coupling agent, and an isocyanate-based silane coupling agent.

The content of the silane coupling agent in the rubber composition may be from 0.1 to 10 parts by mass or from 0.5 to 8 parts by mass with respect to 100 parts by mass of the content of the ethylene-α-olefin-nonconjugated polyene copolymer rubber.

The rubber antioxidant may contain an amine-based rubber antioxidant, a sulfur-based rubber antioxidant, or both of these. The rubber antioxidant can be one that is usually used in a rubber composition. The content of the rubber antioxidant in the rubber composition may be from 0.1 to 40 parts by mass or from 0.1 to 30 parts by mass with respect to 100 parts by mass of the content of the ethylene-α-olefin-nonconjugated polyene copolymer rubber.

Examples of the amine-based rubber antioxidant include naphthylamine-based rubber antioxidants such as phenyl-α-naphthylamine and phenyl-β-naphthylamine; diphenylamine-based rubber antioxidants such as p-(p-toluenesulfonylamide)diphenylamine, 4,4′-bis(α,α-dimethylbenzyl)diphenylamine, alkylated diphenylamine (for example, octylated diphenylamine), dioctylated diphenylamine (for example, 4,4′-dioctyldiphenylamine), a reaction product of diphenylamine with acetone at a high temperature, a reaction product of diphenylamine with acetone at a low temperature, a reaction product of diphenylamine with aniline and acetone at a low temperature, and a reaction product of diphenylamine with diisobutylene; and p-phenylenediamine-based rubber antioxidants such as N,N′-diphenyl-p-phenylenediamine, N-isopropyl-N′-phenyl-p-phenylenediamine, N,N′-di-2-naphthyl-p-phenylenediamine, N-cyclohexyl-N′-phenyl-p-phenylenediamine, N-phenyl-N′-(3-methacryloyloxy-2-hydroxypropyl)-p-phenylenediamine, N,N′-bis(1-methylheptyl)-p-phenylenediamine, N,N′-bis(1,4-dimethylpentyl)-p-phenylenediamine, N,N′-bis(1-ethyl-3-methylpentyl)-p-phenylenediamine, N-(1,3-dimethylbutyl)-N′-phenyl-p-phenylenediamine, N-hexyl-N′-phenyl-p-phenylenediamine, and N-octyl-N′-phenyl-p-phenylenediamine

These may be used singly or in combination.

The amine-based rubber antioxidant may be a diphenylamine-based rubber antioxidant.

The diphenylamine-based rubber antioxidant may be 4,4′-bis(α,α-dimethylbenzyl)diphenylamine, N,N′-diphenyl-p-phenylenediamine, N,N′-di-2-naphthyl-p-phenylenediamine, or any combination thereof.

Examples of the sulfur-based rubber antioxidant include imidazole-based rubber antioxidants such as 2-mercaptobenzimidazole, a zinc salt of 2-mercaptobenzimidazole, 2-mercaptomethylbenzimidazole, zinc salt of 2-mercaptomethylbenzimidazole, and a zinc salt of 2-mercaptomethylimidazole; and aliphatic thioether-based rubber antioxidants such as dimyristyl thiodipropionate, dilauryl thiodipropionate, distearyl thiodipropionate, ditridecyl thiodipropionate, and pentaerythritol-tetrakis(β-lauryl-thiopropionate). These may be used singly or in combination.

The sulfur-based rubber antioxidant may be an imidazole-based rubber antioxidant. The imidazole-based rubber antioxidant may be 2-mercaptobenzimidazole, a zinc salt of 2-mercaptobenzimidazole, 2-mercaptomethylbenzimidazole, a zinc salt of 2-mercaptomethylbenzimidazole, or any combination thereof.

Examples of a rubber antioxidant other than the amine-based rubber antioxidant and sulfur-based rubber antioxidant may include styrenated phenol, 2,6-di-t-butylphenol, 2,6-di-t-butyl-4-methylphenol, 2,6-di-t-butyl-4-ethylphenol, 2,4,6-tri-t-butylphenol, butylhydroxyanisole, 1-hydroxy-3-methyl-4-isopropylbenzene, mono-t-butyl-p-cresol, mono-t-butyl-m-cresol, 2,4-dimethyl-6-t-butylphenol, butylated bisphenol A, 2,2′-methylene-bis(4-methyl-6-t-butylphenol), 2,2′-methylene-bis(4-ethyl-6-t-butylphenol), 2,2′-methylene-bis(4-methyl-6-t-nonylphenol), 2,2′-isobutylidene-bis(4,6-dimethylphenol), 4,4′-butylidene-bis(3-methyl-6-t-butylphenol), 4,4′-methylene-bis(2,6-di-t-butylphenol), 2,2′-thio-bis(4-methyl-6-t-butylphenol), 4,4′-thio-bis(3-methyl-6-t-butylphenol), 4,4′-thio-bis(2-methyl-6-butylphenol), 4,4′-thio-bis(6-t-butyl-3-methylphenol), bis(3-methyl-4-hydroxy-5-t-butylbenzene) sulfide, 2,2′-thio[diethyl-bis-3-(3,5-di-t-butyl-4-hydroxyphenol) propionate], bis[3,3-bis(4-hydroxy-3-t-butylphenol) butyric acid]glycol ester, bis[2-(2-hydroxy-5-methyl-3-t-butylbenzene)-4-methyl-6-t-butylpheny]terephthalate, 1,3,5-tris(3,5-di-t-butyl-4-hydroxybenzyl) isocyanurate, N,N′-hexamethylene-bis(3,5-di-t-butyl-4-hydroxy-hydrocinnamamide), n-octadecyl-3-(4-hydroxy-3,5-di-t-butylphenol) propionate, tetrakis[methylene-3-(3,5-di-t-butyl-4-hydroxyphenyl) propionate]methane, 1,1′-bis(4-hydroxyphenyl)cyclohexane, mono(α-methylbenzene)phenol, di(α-methylbenzyl)phenol, tri(α-methylbenzyl)phenol, 2,6-bis(2-hydroxy-3-t-butyl-5-methylbenzyl)-4-methylphenol, 3,9-bis[2-{3-(3-t-butyl-4-hydroxy-5-methylphenyl)propionyloxy}-1,1-dimethylethyl]-2,4,8,10-tetraoxaspiro[5.5]undecane, 2,5-di-t-amylhydroquinone, 2,6-di-t-butyl-α-dimethylamino-p-cresol, 2,5-di-t-butylhydroquinone, diethyl ester of 3,5-di-t-butyl-4-hydroxybenzylphosphoric acid, catechol, hydroquinone, and 2,2,4-trimethyl-1,2-dihydroquinoline polymer. These can be used singly or in combination.

Molded Article

A molded article according to an embodiment is obtained by molding the rubber composition according to the embodiment described above into a predetermined shape. The molded article is typically a vulcanized rubber composition. The method of producing the molded article according to the present embodiment from the rubber composition can include molding the rubber composition to form a molded article and vulcanizing the rubber composition. The rubber composition may be vulcanized while forming a molded article, or the rubber composition may be formed into a molded article and then the rubber composition forming the molded article may be vulcanized.

The rubber composition can be obtained, for example, by kneading a mixture containing the ethylene-α-olefin-nonconjugated polyene copolymer rubber and other components to be added if necessary. Kneading can be conducted by using an internal mixing machine such as a mixer, a kneader, or a twin screw extruder. The kneading time is, for example, from 1 to 60 minutes. The kneading temperature is, for example, from 40° C. to 200° C.

The vulcanizable rubber composition obtained in the kneading step is molded, for example, by using a molding machine such as an injection molding machine, a compression molding machine, or a hot air vulcanizing apparatus. The heating temperature for molding may be from 120° C. to 250° C. or from 140° C. to 220° C. The time required for molding is, for example, from 1 to 60 minutes. A molded article vulcanized can be obtained by vulcanizing the rubber composition through heating at the time of molding.

Various kinds of products such as hoses, belts, automobile parts, building materials, and vibration damping rubber can be produced by a usual method using the molded article obtained by such a method.

### EXAMPLES

Hereinafter, the present invention will be more specifically described with reference to Examples. However, the present invention is not limited to the following Examples.

1. Synthesis of ethylene-α-olefin-nonconjugated polyene copolymer rubber

### Example 1

Into a first polymerization tank which was made of stainless steel and equipped with a stirrer, hexane was supplied at a velocity of 829.0 g/(hr L), ethylene at a velocity of 39.3 g/(hr L), and propylene at a velocity of 11.7 g/(hr L) per unit time and unit volume of the polymerization tank. Into the first polymerization tank, VOCl₃ was supplied at a velocity of 36.2 mg/(hr L), ethylaluminum sesquichloride (EASC) at a velocity of 144.9 mg/(hr L), and hydrogen at a velocity of 0.11 NL/(hr L). Into the first polymerization tank, 5-ethylidene-2-norbornene was further supplied at a velocity of 2.9 g/(hr L). The temperature of the first polymerization tank was kept at 50° C.

The polymerization solution withdrawn from the first polymerization tank was supplied into a second polymerization tank which was made of stainless steel and equipped with a stirrer and had the same volume as that of the first polymerization tank. Subsequently, into the second polymerization tank, hexane was supplied at a velocity of 412.5 g/(hr L), ethylene at a velocity of 19.7 g/(hr L), and propylene at a velocity of 5.8 g/(hr L) per unit time and unit volume of the polymerization tank. Into the second polymerization tank, VOCl₃ was supplied at a velocity of 19.4 mg/(hr L) and ethylaluminum sesquichloride (EASC) at a velocity of 38.8 mg/(hr L). Into the second polymerization tank, 5-ethylidene-2-norbornene was further supplied at a velocity of 1.5 g/(hr L). The temperature of the second polymerization tank was kept at 51° C. In the second polymerization tank, ethylene-propylene-5-ethylidene-2-norbornene copolymer rubber was produced at 81 g/(hr L) per unit time and unit volume of the polymerization tank. The copolymer rubber recovered from the polymerization solution was dried to obtain a solid copolymer rubber.

### Comparative Examples 1 to 3

Ethylene-propylene-5-ethylidene-2-norbornene copolymer rubber or ethylene-propylene-dicyclopentadiene-5-ethylidene-2-norbornene copolymer rubber was synthesized in the same manner as in Example 1 except that the kinds and amounts of the respective components supplied were changed as described in Table 1. In Comparative Example 1, ethanol was supplied into the first polymerization tank and the second polymerization tank. In Comparative Example 3, dicyclopentadiene was further supplied into the first polymerization tank and the second polymerization tank.

TABLE 1

| | | | |
|---|---|---|---|
| | Comp. | Comp. | Comp. |
| Ex. 1 | Ex. 1 | Ex. 2 | Ex. 3 |

First polymerization tank

| | | | | | |
|---|---|---|---|---|---|
| Hexane | g/hr · L | 829.0 | 242.4 | 228.0 | 727.9 |
| Propylene | g/hr · L | 11.7 | 11.6 | 10.5 | 7.4 |
| Ethylene | g/hr · L | 39.3 | 17.4 | 18.4 | 33.8 |
| VOCl₃ | mg/hr · L | 36.2 | 26.9 | 37.4 | 27.2 |
| EASC | mg/hr · L | 144.9 | 153.1 | 186.8 | 108.9 |
| Ethanol | mg/hr · L | 0 | 12.9 | 0 | 0 |
| Hydrogen | NL/hr · L | 0.11 | 0.068 | 0.033 | 0.24 |
| Dicyclopentadiene | mg/hr · L | 0 | 0 | 0 | 0.44 |
| 5-Ethylidene- | g/hr · L | 2.9 | 1.4 | 1.6 | 2.5 |
| 2-norbornene | | | | | |
| Polymerization | ° C. | 50 | 44 | 48 | 50 |
| temperature | | | | | |

Second polymerization tank

| | | | | | |
|---|---|---|---|---|---|
| Hexane | g/hr · L | 412.5 | 106.1 | 98.8 | 361.4 |
| Propylene | g/hr · L | 5.8 | 5.8 | 5.2 | 3.7 |
| Ethylene | g/hr · L | 19.7 | 8.7 | 9.2 | 16.9 |
| VOCl₃ | mg/hr · L | 19.4 | 15.5 | 28.8 | 13.4 |
| EASC | g/hr · L | 38.8 | 88.4 | 115.2 | 26.8 |
| Ethanol | mg/hr · L | 0 | 7.4 | 0 | 0 |
| Hydrogen | NL/hr · L | 0 | 0 | 0 | 0 |
| Dicyclopentadiene | mg/hr · L | 0 | 0 | 0 | 0.22 |
| 5-Ethylidene- | g/hr · L | 1.5 | 0.68 | 0.78 | 1.3 |
| 2-norbornene | | | | | |
| Polymerization | ° C. | 51 | 47 | 50 | 51 |
| temperature | | | | | |
| Produced amount | g/hr · L | 81 | 45 | 45 | 66 |

### 2. Evaluation

### (1) Intrinsic Viscosity [η]

The reduced viscosity (viscosity number) of a copolymer solution of which the concentration was known was measured in tetralin at 135° C. by using an Ubbelohde viscometer. The intrinsic viscosity of the copolymer rubber was determined from the measurement results according to the calculation method described in “Koubunshi Youeki, Koubunshi Zikkengaku 11 (Polymer Solutions and Polymer Experiments 11)” (1982, published by Kyoritsu Shuppan Co., Ltd.), page 491.

(2) Content of Ethylene Unit and Content of Propylene Unit

The ethylene-α-olefin-nonconjugated polyene copolymer rubber was molded to produce a film having a thickness of about 0.1 mm by using a hot press machine. The infrared absorption spectrum of the film was measured by using an infrared spectrophotometer (IR-810 manufactured by JASCO Corporation). The content of ethylene unit and the content of propylene unit with respect to the total amount of the ethylene unit, the propylene unit and the nonconjugated polyene unit were determined from the infrared absorption spectrum obtained according to the method described in the reference literatures (“Characterization of polyethylene by infrared absorption spectrum by Takayama”, Usami et al. or Die Makromolekulare Chemie, 177, 461 (1976) by Mc Rae, M. A., Maddam S, W. F. et al.).

(3) Iodine Value

Three types of ethylene-propylene-5-ethylidene-2-norbornene copolymer rubbers having different iodine known values in accordance with “JIS K0070-1992 6. Iodine Value” were each molded by a hot press machine to produce films having a thickness of about 0.2 mm The infrared absorption spectrum of each film was measured by an infrared spectrophotometer (IR-700 manufactured by JASCO Corporation). Transmittances of a peak derived from 5-ethylidene-2-norbornene (absorption peak at 1686 cm⁻¹) and a base peak (absorption peak at 1664 to 1674 cm⁻¹) for each film were obtained from the obtained infrared absorption spectrum, and the IR index was calculated by the following formula (I). A is the transmittance of the base peak, B is the transmittance of the peak derived from 5-ethylidene-2-norbornene, and D (mm) is the thickness of the film.

IR index=Log(A/B)/D formula (I)

A calibration curve of iodine values represented by the following formula (II) was obtained from the IR index and the above-described known iodine values. α and β in the formula (II) are each a constant.

Iodine value=α×IR index+β formula (II)

The IR indexes of the films obtained by molding the ethylene-propylene-5-ethylidene-2-norbornene copolymer rubbers were measured, and, from the obtained value and the calibration curve, the iodine values of the ethylene-propylene-5-ethylidene-2-norbornene copolymer rubbers were determined.

(4) Mooney Viscosity

The Mooney viscosities at 125° C. (ML₁₊₄ 125° C(copolymer rubber)) of the copolymer rubbers were measured according to JIS K6300-1994.

(5) Proportion of Cyclohexane Insoluble Component

A portion having a thickness of 1 mm was cut off from the side face of the solid copolymer rubber by using scissors. The small pieces cut were further cut to obtain a substantially cubic sample of 1 mm square. The mass (A) of about 0.5 g of the sample obtained was precisely weighed by using an electronic balance. Subsequently, the sample was placed in an Erlenmeyer flask with a stopper having a volume of 500 mL. Thereinto, 250 mL of cyclohexane was weighed by using a measuring cylinder and poured to immerse the sample in the cyclohexane. In the cyclohexane, 6-bis(tert-butyl)-4-methylphenol (Sumilizer BHT) having a concentration of 0.1% by mass had been dissolved in advance. The Erlenmeyer flask was left to stand in a constant temperature water bath at 25° C. for 24 hours. The Erlenmeyer flask taken out from the constant temperature water bath was stoppered and then shaken for 1 hour by using a shaker The shaking speed was set to 120 rpm.

The mass (B) of a 120-mesh wire gauze was precisely weighed by using an electronic balance. The solution in the flask was filtered through this wire gauze. At the time of filtration, the residue in the Erlenmeyer flask was washed toward the wire gauze with about 20 mL of new cyclohexane. The wire gauze after filtration was dried on a hot plate at from 60° C. to 90° C. for 3 hours together with the filtered solid components on the wire gauze. The wire gauze after drying was cooled to room temperature in a desiccator over about 30 minutes. The mass (C) of the wire gauze after cooling was precisely weighed by using an electronic balance.

The proportion (% by mass) of the cyclohexane insoluble component was calculated by substituting the mass A of the sample before being immersed in cyclohexane, the mass B (tare) of the wire gauze, and the mass C of the wire gauze after filtration and drying into the following equation.

Proportion of Cyclohexane Insoluble Component={(C−B)/A}×100

(6) Tan δ Ratio

The viscoelasticity of the copolymer rubber was measured by using a viscoelasticity measuring apparatus (RUBBER PROCESS ANALYZER RPA 2000P manufactured by ALPHA TECHNOLOGIES) under the following conditions.

Temperature: 100° C.

Strain: 13.95%

Frequency: 5 cpm or 1000 cpm

From the measurement results, tan δ (100° C., 5 cpm) which was the loss coefficient at a frequency of 5 cpm and tan δ (100° C., 1000 cpm) which was the loss coefficient at a frequency of 1000 cpm were determined. The tan δ ratio was calculated by substituting these values into the following equation.

Tan δ ratio=tan δ (100° C., 5 cpm)/tan δ (100° C., 1000 cpm)

(7) Glass Transition Temperature (Tg)

The differential scanning calorie (DSC) of the copolymer rubber was measured at a rate of temperature increase of 5° C./min. The temperature at the midpoint of the glass transition portion in the DSC thermogram obtained was taken as the glass transition temperature.

(8) Molecular Weight Distribution (Mw/Mn)

The values of weight average molecular weight (Mw) and number average molecular weight (Mn) of the copolymer rubber in terms of standard polystyrene were measured by gel permeation chromatography (GPC) under the following conditions. The molecular weight distribution (Mw/Mn) was calculated from the Mw and Mn obtained.
GPC apparatus: HLC-8121 GPC/HT (trade name) manufactured by Tosoh Corporation
Column: TSKgel GMHHR-H(S) HT (trade name) manufactured by Tosoh Corporation
Standard substance for molecular weight: polystyrene having molecular weight of 500 or more and 20,000,000 or less
Flow rate of eluting solvent: 1.0 mL/min
Concentration of sample: 1 mg/mL
Measured temperature: 140° C.
Eluting solvent: orthodichlorobenzene
Injection volume: 500 μL
Detector: differential refractometer

(9) Tensile Strength

By using a Banbury mixer (manufactured by Kobe Steel, Ltd.), 100 parts by mass of the copolymer rubber, 5 parts by mass of zinc oxide, 1 parts by mass of stearic acid (“ASAHI 60UG” manufactured by Asahi Carbon Co. Ltd.) and 80 parts by mass of paraffin-based oil (“Dianna PS4300” manufactured by Idemitsu Kosan Co.,Ltd.) were kneaded for 4 minutes at a rotor rotating speed of 80 rpm. A mixture of the resulting kneaded material, 1.5 parts by mass of sulfur, 1.25 parts by mass of Zinc di-n-butyldithiocarbamate (“Rhenogran ZDBC-80” manufactured by LANXESS), 1.25 parts by mass of tetramethylthiuram disulfide (“Rhenogran TMTD-80” manufactured by LANXESS), 1.25 parts by mass of N-cyclohexylbenzothiazolesulfenamide (“Rhenogran CBS-80” manufactured by LANXESS), and 0.71 pars by mass of dipentamethylenethiuram tetrasulfide (“Rhenogran DPPT-70” manufactured by LANXESS) was kneaded by using an 8-inch open roll (manufactured by KANSAI ROLL Co., Ltd.) to obtain a rubber composition.

The rubber composition obtained was compression-molded at a set temperature of 170° C. for 15 minutes by using a 100-ton press (trade name: PSF-B010 manufactured by KANSAI ROLL Co., Ltd.), and a dumbbell-shaped No. 3 test piece described in JIS K6251-1993 was fabricated by conducting molding and vulcanization at the same time. This test piece was subjected to a tension test in an atmosphere at 23° C. and a tension speed of 500 mm/min. As the tension test, a tension testing machine QUICK READER P-57 (manufactured by Ueshima Seisakusho Co., Ltd.) was used.

(8) Stability of Viscosity (ΔML)

By using a Banbury mixer (manufactured by Kobe Steel, Ltd.), 100 parts by mass of the copolymer rubber, 5 parts by mass of zinc oxide, 1 parts by mass of stearic acid (“ASAHI 60UG” manufactured by Asahi Carbon Co. Ltd.) and 80 parts by mass of paraffin-based oil (“Dianna PS430” manufactured by Idemitsu Kosan Co., Ltd.) were kneaded for 4 minutes at a rotor rotating speed of 80 rpm. A mixture of the resulting kneaded material, 1.5 parts by mass of sulfur, 1.25 parts by mass of Zinc di-n-butyldithiocarbamate (“Rhenogran ZDBC-80” manufactured by LANXESS), 1.25 parts by mass of tetramethylthiuram disulfide (“Rhenogran TMTD-80” manufactured by LANXESS), 1.25 parts by mass of N-cyclohexylbenzothiazolesulfenamide (“Rhenogran CBS-80” manufactured by LANXESS), and 0.71 pars by mass of dipentamethylenethiuram tetrasulfide (“Rhenogran DPPT-70” manufactured by LANXESS) was kneaded by using an 8-inch open roll (manufactured by KANSAI ROLL Co., Ltd.) to obtain a rubber composition. The Mooney viscosity of the obtained rubber composition at 100° C. (ML₁₊₄ 100° C. (rubber composition)) was measured according to JIS K6300-1994. The difference AML between ML₁₊₄ 125° C. (copolymer rubber) and ML₁₊₄ 100° C. (rubber composition) was determined. A small ΔML means high viscosity stability at the time of kneading.

TABLE 2

| | | Comp. | Comp. | Comp. |
|---|---|---|---|---|
| | Ex 1 | Ex. 1 | Ex. 2 | Ex. 3 |
| Intrinsic viscosity [η] | 2.3 | 2.2 | 2.3 | 2.1 |
| [dl/g] | | | | |
| Ethylene unit content | 73 | 55 | 60 | 78 |
| [% by mass] | | | | |
| Propylene unit content | 22 | 41 | 34 | 16 |
| [% by mass] | | | | |
| Iodine value | 11 | 9 | 12 | 11 |
| ML_{1 + 4} 125° C. (copolymer) | 80 | 83 | 100 | 72 |
| Proportion of cyclohexane | 27.5 | 0.1 | 12.3 | 18.9 |
| insoluble component | | | | |
| [% by mass] | | | | |
| Tanδ ratio | 3.2 | 2.5 | 2.9 | 2.5 |
| Tg [° C.] | −42 | −55 | −52 | −36 |
| Mw/Mn | 2.6 | 2.5 | 2.7 | 2.5 |
| Tensile strength | 18.1 | 14.7 | 15.9 | 18.8 |
| [MPa] | | | | |
| ΔML | 10 | 15 | 29 | 12 |

From the results in Table 2, it has been confirmed that the ethylene-α-olefin-nonconjugated polyene copolymer rubber in which the proportion of the cyclohexane insoluble component is from 0.3% to 50% by mass and the tan δ ratio is from 3.0 to 20 forms a molded article having a favorable mechanical strength (tensile strength) and has a stable viscosity in the process of kneading conducted to obtain a rubber composition.

1. An ethylene-α-olefin-nonconjugated polyene copolymer rubber satisfying the following requirements (A) and (B):
(A) a proportion of a cyclohexane insoluble component at 25° C. is from 0.3% to 50% by mass with respect to a mass of the ethylene-α-olefin-nonconjugated polyene copolymer rubber; and
(B) a tan δ ratio calculated by the following equation:
tan δ ratio=tan δ (100° C., 5 cpm)/tan δ (100° C., 1000 cpm)
is from 3.0 to 20, wherein
tan δ (100° C., 5 cpm) and tan δ (100° C., 1000 cpm) are a loss tangent at 100° C. and a frequency of 5 cpm and a loss tangent at 100° C. and a frequency of 1000 cpm, respectively.

2. The ethylene-α-olefin-nonconjugated polyene copolymer rubber according to claim 1, wherein a content of an ethylene unit is from 50% to 90% by mass with respect to a total amount of the ethylene unit, an α-olefin unit and a nonconjugated polyene unit.

3. A rubber composition comprising the ethylene-α-olefin-nonconjugated polyene copolymer rubber according to claim 1.
